(19) United States
(12) Patent Application Publication
(10) Pub. No.: US 2006/0266831 A1
(43) Pub. Date: Nov. 30, 2006

(54) System & apparatus for improving proximity smartcard security

(76) Inventor: Douglas Kozlay, Timonium, MD (US)

Correspondence Address: NIXON & VANDERHYE, PC, 901 NORTH GLEBE ROAD, 11TH FLOOR, ARLINGTON, VA, 22203, US

(21) Appl. No.: 11/141,485

(22) Filed: May 31, 2005

(51) Int. Cl. G06K 7/08; G06K 19/06

(52) U.S. Cl. 235/451; 235/492

(57) ABSTRACT

A pushbutton-enabled, wireless proximity smartcard or passport system is disclosed for improving smartcard security. The apparatus of the invention comprises a pushbutton-enabled smartcard or other pushbutton-enabled identity credential device that requires a user to press down upon an enabling switch embedded in the smartcard, prior to data transmission. This prevents the identity device from being deliberately or accidentally read at times and places that are unintended. The system of the invention includes users, proximity smartcards or other wirelessly-operable identity credentials, and smartcard readers connected to a host system. The method, apparatus, and system of the present invention are particularly suited to reducing exposure to risks associated with unwanted, unintended electronic intrusions on otherwise desirable electronic products.

### BACKGROUND OF THE INVENTION

1. Field of the Invention

The field of the invention is wireless smartcard security; more particularly, the present invention provides improved contactless security-oriented wireless smartcards, passports and other wireless electronic credentials.

2. Related Art

To date, the Inventor was unable to find directly comparable or analogous products or patents related to the present invention.

### NECESSITY OF THE INVENTION

Smartcard use is becoming widespread, as worldwide adoption of smartcard technology accelerates. Given the exponential increase in smartcard usage, it is well known that security concerns and security incidents are also on the rise. Similarly, wireless (“contactless”) smartcards, passports, and other wireless credential devices are considered by some to be a risky technology, especially given the increasing incidence of fraud, identity theft, employee theft, unwanted electronic intrusion, etc.

Security challenges of “contactless” technology are summed up by cryptanalysis expert Bruce Schneier (founder/CTO of Counterpane Internet Security, Inc.), to wit:
“ . . . [Contactless] RFID chips are like smart cards, but they can be read from a distance. A receiving device can “talk” to the chip remotely, without any need for physical contact, and get whatever information is on it. Passport officials envision being able to download the information on the chip simply by bringing it within a few centimeters of a reader. Unfortunately, RFID chips can be read by any reader, not just the ones at passport control . . . anyone carrying around an RFID passport is broadcasting his identity. Think about what that means for a minute. It means that a passport holder is continuously broadcasting his name, nationality, age, address, and whatever else is on the RFID chip. It means anyone with a reader can learn that information, without a passport holder's knowledge or consent. It means that pickpockets, kidnappers, and terrorists can easily, surreptitiously, pick Americans out of a crowd. It's a clear threat to both privacy and personal safety. The administration claims that the chips can only be read from a few centimeters away, so there's no potential for abuse. This is a spectacularly naive claim. All wireless protocols can work at much longer ranges than specified. In tests, RFID chips have been read by receivers 20 meters away. Improvements in technology are inevitable.” Source: http://www.schneier.com/crypto-gram-0410.html#3

### OBJECTS OF THE INVENTION

Accordingly, it is one primary object of the present invention, to provide a pushbutton-enabled contactless smartcard apparatus, which only allows wireless data transmission when a pushbutton switch is held closed.

It is a related primary object, to provide methods for improving wireless electronic smartcard and chip card security.

It is another related primary object, to provide systems for improving wireless smartcard and chip card security.

### SUMMARY OF THE INVENTION

This invention requires that the cardholder press a button on a proximity card in order to enable the card to transmit a response. Since RF or IR identification devices can be read at times and places where the bearer does not intend them to be read, and since the presence of encrypted data in the response from the device can have the undesired effect of confirming the importance of the bearer, there is a need to prevent any transmission, from the card until the bearer enables it.

This invention discloses two embodiments of the solution, antenna loop enabling and processor enabling, although the claims will disclose other possible embodiments. The discussion, below, describes an identification card, although this invention could be implemented for other identifying devices, such as electronic passports and other electronic credential devices.

### BRIEF DESCRIPTION OF THE FIGURES AND REFERENCE NUMERALS

Figures

FIG. 1—Activating a contactless smartcard so that it can perform radio functions

FIG. 2—Finger pressing a button to close an antenna circuit

FIG. 3—Proximity card with embedded pressure-sensing switch in antenna circuit

FIG. 4—Detail of embedded pressure-sensing switch in the antenna circuit

FIG. 5—Proximity card with pressure-sensing switch connected to processor

FIG. 6—Detail of pressure-sensing switch connected to the processor

FIG. 7—Combination contact card and switch-enabled contactless card

### REFERENCE NUMERALS

2—Finger pressing a button to enable wireless transceiver

4—Processor performing contactless smartcard function

6—Mechanical or electronic switch to sense finger presence

8—Loop antenna or IR transceiver to receive and transmit and receive signals

10—Plastic card body

12—Spring-like support under the button/switch

14—Mounting surface for the processor chip with antenna loop connections

16—Radio frequency or Infrared link between the contactless card and a reader

18—Reader for contactless cards

20—Smartcard processor and contacts

### DETAILED DESCRIPTION OF THE INVENTION

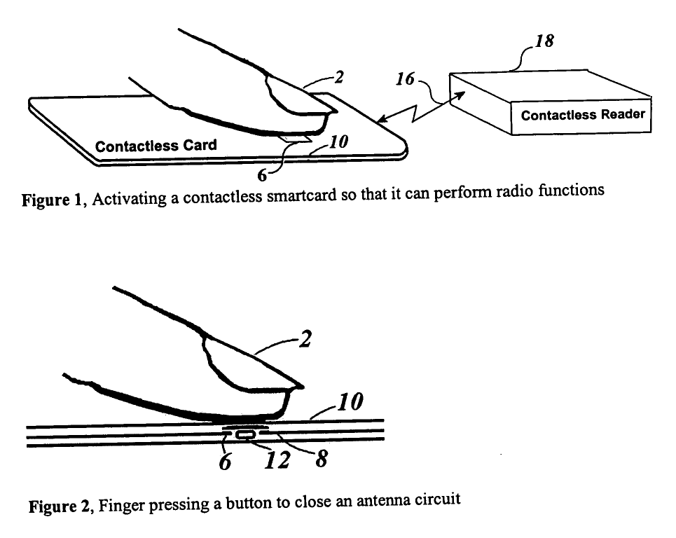

FIG. 1 illustrates a proximity card reader 18, which emits a radio frequency signal to a proximity card 10 and awaits a response from the card. Also in FIG. 1, finger 2 is pressing on a switch 6, embedded in card 10 to enable transmission. In either embodiment, the user must press the button when the card is to be used in order for the card to respond to external RF signals. If button switch 6 is not pressed, then the card remains passive and does not reveal the presence of the cardholder. The means by which this is accomplished is different for the two illustrative embodiments described below.

Antenna Loop Enabling

FIG. 2 describes a normally-open dome or membrane switch 6 that is commonly used in thin calculators and other thin electronic devices. This switch could also be an electronic capacitive or electrostatic switching device, well known to the art to detect the presence of a fingertip without mechanical contacts. It can also be a biometric authenticating activator for a smartcard which enables the card only when the enrolled fingerprint is presented to the on-card sensor as taught in Lofberg U.S. Pat. No. 4,582,985. When the switch is held pressed, for example, the conductive switch membrane embedded in the card will close the circuit in the antenna 8 so that the proximity card can receive signals from the reader. When the finger is not pressing on the button, elastic stop 12 returns the switch to the open position, disabling the antenna loop.

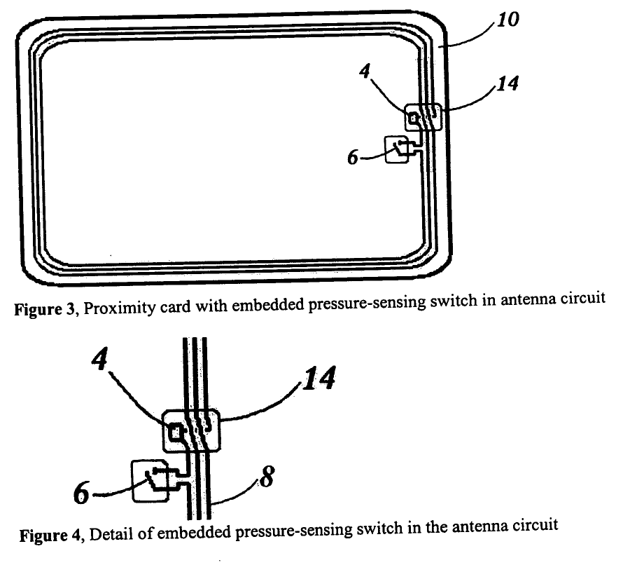

FIG. 3 is a diagram of the electrical circuit within the body of proximity card 10 and the components are expanded in FIG. 4 for clarity. A typical RF transceiver and processor chip 4 is shown on a mounting surface 14. In this embodiment, the processor, mounting component and antenna loop can use existing parts, modified only by soldering switch 6 into the loop. This enables the enabling switch to be introduced into existing proximity card designs.

Processor Enabling

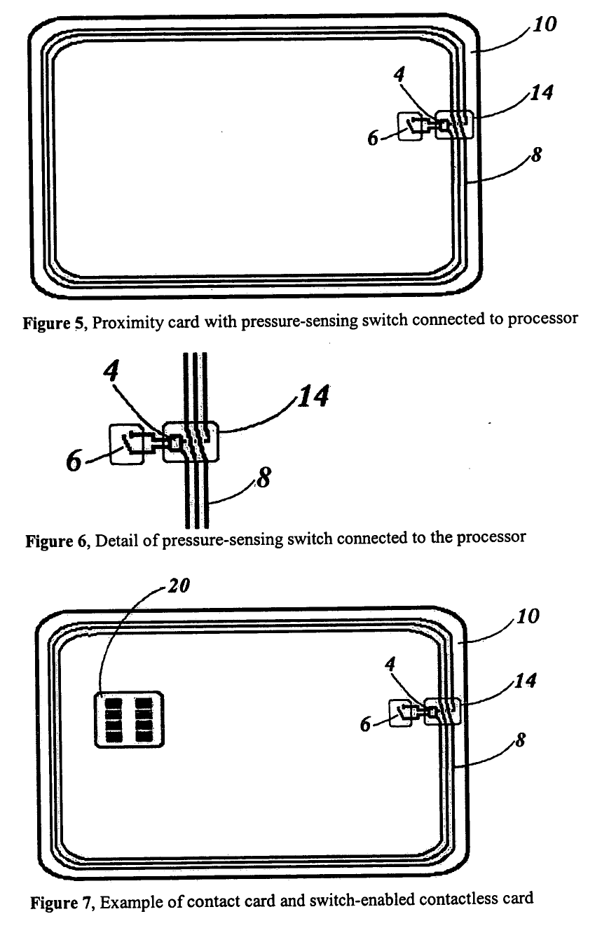

FIG. 5 (and detail FIG. 6) describe the second embodiment in which the switch 6 is sensed by an input port on processor (and RF or IR transceiver) chip 4 which is programmed to wait for switch closure before transmitting data using antenna loop 8. The advantage of this embodiment is that the momentary switch needs only to be pressed once when the card is within the RF field in the active vicinity of the reader in order to enable processor 4 to transmit. The processor program will remember that it has been enabled from a momentary switch 6 closure until the card is removed from the RF field. When RF-derived power has been lost, the processor no longer retains memory of the activation and, therefore, subsequent card use will require another button push. In case the card is exposed to an RF field for an extended period of time, the processor can be programmed to timeout after a pre-established interval and thereby disable transmission.

FIG. 7 illustrates the use of this invention to enhance proximity card security on “combination” (hybrid) contact and contactless cards. The contactless features on this combination card will benefit from the additional security of the present invention.

In the foregoing specification, the invention has been described with reference to specific exemplary embodiments thereof. It will, however, be evident that various modifications and changes may be made thereunto without departing from broader spirit and scope of the invention as set forth in the appended claims. For example, various techniques can be used to implement the disclosed invention. Also, the specific logic presented to accomplish tasks within the present invention may be modified without departing from the scope of the invention. Many such changes or modifications will be readily apparent to one of ordinary skill in the art. The specification and drawings are, accordingly, to be regarded in an illustrative sense, the invention being limited only by the provided claims.

I claim:

1. A pushbutton-enabled smartcard apparatus, comprising:
a. a smartcard substrate;
b. at least one processor coupled to said smartcard substrate;
c. at least one pushbutton actuated switch coupled to one of said at least one processor;
d. a wireless data transmission subsystem coupled to said at least one processor and further coupled to said at least one pushbutton-actuated switch; and
e. at least one antenna coupled to said data transmission subsystem and further coupled to said at least one processor.

2. The pushbutton-enabled apparatus of claim 1, wherein said at least one processor is operable only after first wirelessly receiving electrical power of sufficient voltage to energize said processor, and then said at least one momentary pushbutton-actuated switch has been closed.

3. The pushbutton-enabled apparatus of claim 1, wherein said at least one antenna is operable only when said at least one pushbutton-actuated switch is held closed during data transmission.

4. The pushbutton-enabled apparatus of claim 1, wherein said pushbutton switch comprises at least one from (but is not limited to) the group of mechanical contact switch, conductive membrane switch, snap-dome switch, tact switch, electrostatic proximity switch, capacitive proximity detecting switch, piezoelectric switch, semiconductor pressure switch, and biometric fingerprint authenticator switch.

5. A method for improving smartcard security, comprising the steps of:
a. enrolling at least one authorized user into at least one authorized pushbutton-enabled smartcard;
b. enrolling said at least one authorized pushbutton-enabled smartcard into a host system connected to a contactless smartcard reader;
c. during card use, verifying in said pushbutton-enabled smartcard that an embedded pushbutton-enabling switch is closed before data transmission is enabled;
d. verifying in said host system connected to said contactless smartcard reader that data messages received from said smartcard were originated from an enrolled smartcard; and
e. granting access to at least one controlled resource to a verified enrolled smartcard by said host system connected to said contactless smartcard reader.

6. The method of claim 4, wherein said at least one controlled resource further comprises at least one from (but is not limited to) the group of physical resources, logical resources, financial resources, information technology resources, digital media resources, network resources, telecommunications resources, and security resources.

7. A system for improving smartcard security, comprising:
a. at least one user;
b. at least one pushbutton-enabled smartcard apparatus; and
c. at least one host system connected to a contactless smartcard reader, wherein said reader is adapted for receiving data messages from said pushbutton-enabled smartcard apparatus and wherein said reader is further adapted for granting access to controlled resources after verification that said smartcard is an enrolled smartcard.
